(19) United States
(12) Patent Application Publication
(10) Pub. No.: US 2025/0351798 A1
(43) Pub. Date: Nov. 20, 2025

(54) BIOCHAR GRANULE CONTAINING PELLETS

(71) Applicant: The Andersons Inc., Maumee, OH (US)

(72) Inventor: Judi Anderson, Maumee, OH (US)

(73) Assignee: The Andersons Inc., Maumee, OH (US)

(21) Appl. No.: 19/208,777

(22) Filed: May 15, 2025

Related U.S. Application Data
(60) Provisional application No. 63/648,283, filed on May 16, 2024.

(51) Int. Cl. A01K 1/015; C09K 17/32

(52) U.S. Cl. CPC A01K 1/0155; C09K 17/32

(57) ABSTRACT

A pellet material formed of biochar granules present from 5 to 100 percent by total weight of the dry weight of the pellet and at least one of carrier granules or a binder component forming a matrix retaining the biochar granules. Additionally, a pelletized animal bedding and litter material formed of biochar present from 5 to 85 percent by total weight of the dry weight of the material, one or more of a fragrance, pheromone, and clumping material, and a binder component forming a matrix retaining the biochar, and the one or more of the fragrance, the pheromone, and the clumping material. Furthermore, a pelletized carrier and soil amendment material formed of biochar present from 5 to 85 percent by total weight of the dry weight of the material, one or more active ingredients, and a binder component forming a matrix retaining the biochar granules, and the active ingredients.

### RELATED APPLICATIONS

This application claims priority benefit of U.S. Provisional Application Ser. No. 63/648,283, filed 16 May 2024, the contents of which are hereby incorporated by reference.

### FIELD OF THE INVENTION

The present invention relates in general to biochar granules, and in particular to biochar granules for use in granular of pelletized animal bedding, animal litter, or as a carrier in a soil amendment.

### DESCRIPTION OF THE RELATED ART

Waste and byproducts produced from municipal, industrial, or agricultural generators are typically comprised of a quantity of solids generated from biomass from agricultural operations, combustion residues from waste to energy facilities, and biosolids and residues from water or sewage treatment facilities. Over one billion tons of biosolids from municipal sewage sludge, and manure from livestock operations are generated in the United States alone. Disposal or subsequent use of biosolids, combustion residues and biomass materials are generally by application to crop land, range land, or forests, landfill disposal, or release into water bodies.

Combustion residues are generally handled as municipal solid waste (MSW), but there is significant controversy concerning the proper management due to the variable regulatory classification as hazardous or non-hazardous waste. There is a lack of useful federal guidance on this area, and problems such as heavy metal content, leachable caustic salts, crystalline silica, etc. Despite the promising potential for beneficial reuse as fertilizer, less than about 5% is utilized in the U.S.A, with somewhat greater reuse in other countries.

Biomass from agricultural operations, such as manures and crop residues, are generally unregulated. Agricultural biomass is being studied for use as energy producing feedstocks for various fuels such as ethanol, syngas, and ‘bio-oil,’ but so far there is little such usage relative to the available supply. With some exceptions such as composting, production of ‘teas’ and soluble salt extraction, animal bedding, burning for fuel, and feed usage, most agricultural biomass is disposed via land or water disposal or open burning. Due to the relatively low value of these materials and the transport costs from production to use sites, the few beneficial uses are generally economically marginal, often requiring some form of public subsidy.

The United States Environmental Protection Agency (EPA) requires that biosolids from municipal waste facilities be stabilized prior to land application. Several stabilization processes may be used including anaerobic digestion and dewatering. Dewatering, for example, is also used to improve subsequent handling characteristics of the materials. Despite the existing federal regulation, various state regulations, corporate policies, and local ordinances provide obstacles to the beneficial reuse of such materials due to concerns regarding exposure to pathogens, unregulated contaminants such as pharmaceutical residues, and noxious odors.

Particles that include dispersible granules (DG) of biosolids or biochar are disclosed in (U.S. Pat. No. 11,332,414) and spherical dispersing granules are taught that foster granule transit to subsurface regions. Particles of biochar DG have a low moisture content and are resistant to breakage during handling resulting in a dust free, free flowing product. These particles have the characteristic of being dust-free particles until being wetted and then disintegrating over a span of seconds to days into constituent granules that are sized to penetrate a contacting soil to carry biochar particulate into the subsoil.

Biochar is a specially produced charcoal that is a by-product of pyrolysis gas production whereby waste agriculture products, wood, manures, forestry residues, or waste is pyrolysed, or roasted at high temperature in a reduced oxygen atmosphere to drive off volatile gases, these volatile gases can be used to run engines, boil water, and generate electricity. The resultant biochar is a carbon skeleton that is devoid of Hodges carbonyls. Biochar surfaces are normally negatively charged, which facilitates the electrostatic attraction of positively charged cationic organic compounds. The porosity of biochar substantially increases the available surfaces of the biochar. For example, a gram of biochar has a BET-measured surface area of 500 to 1300 m2/gram. The high surface areas can be attributed to the retention of the channels present in the plants from which the biochar is formed. Phloem and xylem are exemplary of plant anatomical features traversed by such channels. Biochar also tends to be basic in pH, owing to ash content and as a result soil pH can be negatively affected but the pH of biochar ranges from 4.6 to 9.3.

Biochar offers a number of benefits for animal bedding and soil health that are related to the extremely degree of porosity. The porous structure of biochar is found to be effective at retaining both water and water-soluble nutrients. As a result of forming a habitat for microorganisms and the leaching of nutrients into the soil, biochar becomes an extremely effective soil amendment promoting good soil and, in turn, the health of plants growing therein. Biochar has also been shown to reduce leaching of harmful bacteria applied to soil, such as E. coli with variables that can be applied to enhance this property including application rate, feedstock, pyrolysis temperature, soil moisture content, soil texture, and surface properties of the bacteria. For plants that require high potash and elevated pH, biochar can be used as a soil amendment to improve yield. In addition, biochar can improve water quality, reduce soil emissions of greenhouse gases, reduce nutrient leaching, reduce soil acidity, and reduce irrigation and fertilizer requirements. For example, modest additions of biochar to soil reduce nitrous oxide emissions by up to 80% and eliminate methane emissions, which are both more potent greenhouse gases than carbon dioxide. Biochar was also found under certain circumstances to induce plant systemic responses to foliar fungal diseases and to improve plant responses to diseases caused by soil borne pathogens. M. Kolton et al., “Biochar-stimulated plant performance is strongly linked to microbial diversity and metabolic potential in the rhizosphere”, New Phytol., 213(3), 1393-1404 (2017).

While innovative products inclusive of biochar have been introduced by applicant, there is a need for even more innovative products that use waste products, particularly waste agriculture products, in the form of biochar. There is additionally a need for a versatile biochar granule that may be used in a variety of products.

### SUMMARY OF THE INVENTION

The present invention provides a pellet material formed of granules, where the pellet includes biochar granules present from 5 to 100 percent by total weight of the dry weight of the inventive pellet and at least one of carrier granules or a binder component forming a matrix retaining the biochar granules.

Additionally the present invention provides a pelletized animal bedding and litter material formed of granules where the pellets include biochar present from 5 to 85 percent by total weight of the dry weight of the material, one or more of a fragrance, a pheromone, and a clumping material, and a binder component forming a matrix retaining the biochar, and the one or more of the fragrance, the pheromone, and the clumping material.

Furthermore, the present invention provides a pelletized carrier and soil amendment material formed of granules, where the pellets include biochar present from 5 to 85 percent by total weight of the dry weight of the material, one or more active ingredients, and a binder component forming a matrix retaining the biochar granules, and the one or more active ingredients.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings wherein:

FIG. 1 is a schematic of a granule of an inventive pelletized animal bedding and litter material formed of granules that include biochar, cob, dolomite, granite, wood, paper, bagasse, sand, Granlime, agricultural by-products, nut shells, grain chaff, rice hulls, oat straws, cotton shields, and other ag or consumer waste, (agricultural material or waste) and a binder;

FIG. 2 is a schematic of a granule of an inventive granular animal bedding and litter material formed of granules that include biochar, a fragrance, a pheromone, and/or a clumping material, and/or a binder; and

FIG. 3 is a schematic of a granular carrier and soil amendment material formed of granules that include biochar, one or more active ingredient, and a binder.

### DETAILED DESCRIPTION OF THE INVENTION

The present invention relates to a versatile biochar granule that is easily incorporated into a wide variety of end products that benefit from the unique and advantageous characteristics of biochar, including animal beddings, animal litters, and soil amendments. The biochar granule provides not only versatility for end product application, but also improved storage capabilities for biosolid materials improving the quality of the biochar granule and the end product material while also decreasing negative storage consequences such as odor emanation or degradation.

The following description of the preferred embodiment(s) is merely exemplary in nature and is in no way intended to limit the scope of the invention, its application, or uses, which may, of course, vary. The invention is described with relation to the non-limiting definitions and terminology included herein. These definitions and terminology are not designed to function as a limitation on the scope or practice of the invention but are presented for illustrative and descriptive purposes only. One of ordinary skill in the art readily understands that the individual components of the inventions are interchangeable and their description with respect to a single embodiment does not preclude their use in alternative embodiments.

It is to be understood that in instances where a range of values are provided herein, that the range is intended to encompass not only the end point values of the range, but also intermediate values of the range as explicitly being included within the range and varying by the last significant figure of the range. By way of example, a recited range of from 1 to 4 is intended to include 1-2, 1-3, 2-4, 3-4, and 1-4.

As used herein, the term “humics” refers to humic acid, fulvic acid, and salts thereof such as sodium, potassium, and calcium salts, which define humates, and combinations thereof. It is appreciated that humics and humate salts are naturally occurring substances that as a result, vary in relative ratios of component parts.

According to embodiments, the versatile biochar granule is sourced from one or more of cob, rice hulls, wood chips, grasses, nut shells, corn stover, bagasse, peanut hull, vines, pulp, waste paper, cardboard, and grain chaff. According to some embodiments, the biochar granule is sourced from biosolids. As used herein, biosolids are optionally from industrial, municipal, animal, or other source. Sources of biosolids are illustratively discussed in U.S. Pat. No. 6,409,650, the contents of which are incorporated herein by reference. Biosolids are optionally waste derived from animal sources. Animal sources illustratively include humans, non-human primates, goats, sheep, pigs, equine, bovine, rodent, deer, or other animal source. Municipal sewage wastes illustratively include human biowastes, household scraps, sanitary paper products and other biological components, as well as mineral matter and small amounts of chemical products, such as solvents, acids, alkalis, and heavy metals, introduced into the waste stream through the municipal sewer system such as solvents, acids, alkalis, and heavy metals. The animal wastes can be mixed with other organic materials such as sawdust or straw, biochar, or they may be mixed with mineral wastes. Still other suitable sources of biosolids are pulp and paper mill sludges, waste oil products including greases and waxes, and wastes which are rich in organic debris dredged from harbors or estuaries.

Biosolids are optionally dewetted into a substantially dry form of such as size so as to be substantially dispersed within mineral fragments in an inventive granule. The types of biosolids operable for use in the invention illustratively include Class A and Class B (classes indicate the degree of pathogen reduction). These biosolids are illustratively produced by treatment processes that generate liquid, dewatered, heat dried, air-dried, composted, digested, or alkaline stabilized materials.

A range of treatments can be applied to disinfect the biosolids. Such treatments include pasteurization (dry heat), aerobic (oxidative) or anaerobic digestion, composting, lime stabilization, liquid storage, and dewatering and dry storage.

According to some embodiments, the versatile biochar granules are typically sized to have less than 5 weight percent being +40 mesh and more than 20 weight percent being −100 mesh. In still other inventive embodiments, the biochar are 100 weight percent being −40 mesh. In still other inventive embodiments, greater than 40 weight percent of the biochar are −100 mesh weight percent. In still other inventive embodiments, greater than 60 weight percent of the biochar are −100 mesh weight percent. In still other inventive embodiments, greater than 5 weight percent of the biochar are −200 mesh weight percent. In still other inventive embodiments, greater than 30 weight percent of the biochar are −200 mesh weight percent.

Typical loadings of biochar in an inventive particle range from 5 to 80 by total weight of the dry weight of the inventive particle and defines a weight ratio relative to humics 0.05-4.0:1 biochar:humics. Without intending to be bound to a particular theory, the friable nature of biochar compared to humics is mitigated to yield an attrition resistant inventive particle by grinding the humics to include at least 5 weight percent of −200 mesh humics that can filler interstices between larger granules of humics and biochar.

According to embodiments, the versatile biochar granule is suitable for easy inclusion in wide a variety of end products that benefit from the unique and advantageous characteristics of biochar. The biochar granule provides not only versatility for end product application, but also improved storage and quality capabilities for such products.

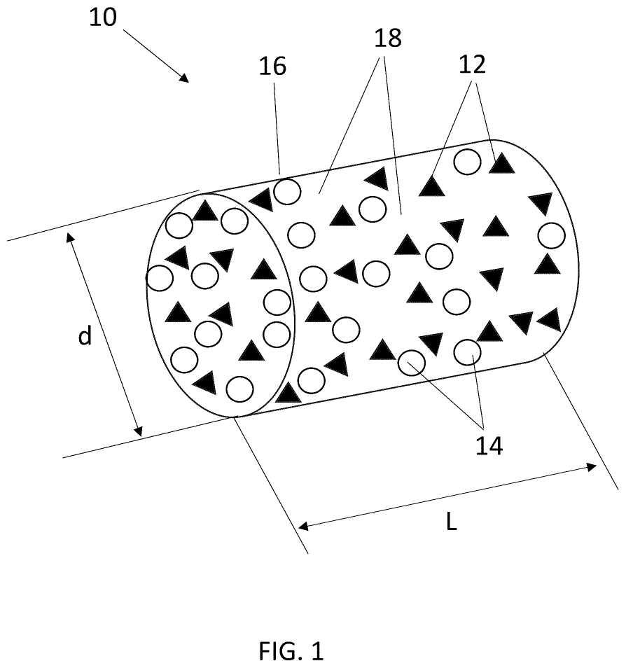

According to embodiments, the versatile biochar granule is part of a pelletized animal bedding and litter material. As shown in FIG. 1, a pellet 10 of an inventive pelletized animal bedding and litter material formed of granules includes biochar granules 12 depicted graphically as filled triangles, as above, 14 depicted graphically as open circles, and a binder 18 that forms a matrix that defines a pellet surface 16 with a pellet length, L, and pellet diameter, d. According to embodiments, a pelletized animal bedding and litter material includes biochar granules present from 5 to 100 percent by total weight of the dry weight of the inventive pellet, 95% to 0% as above, and a binder component forming a matrix retaining the biochar granules and the as above. According to embodiments, each of the pellets of the pelletized animal bedding and litter material have a length that ranges from 5 mm to 45 mm, and a diameter that ranges from between 5 mm to 10 mm.

As used herein an animal bedding is a material that can be used to line a cage of a domesticated or laboratory animal for nesting, play, stimulation, and/or the absorption of waste. An animal litter product is a material that can be used to line a cage or waste collection bin of a domesticated or laboratory animal for nesting, play, stimulation, and/or the absorption of waste.

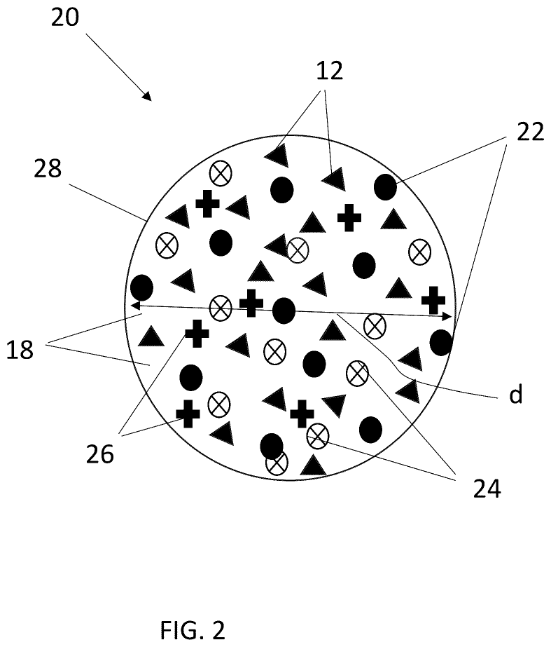

According to embodiments, the versatile biochar granule is part of a granular animal bedding and litter material. As shown in FIG. 2, a granule 20 of the animal bedding and litter material includes the biochar granules 12 described above and depicted graphically as filled triangles; one or more of a fragrance 22 depicted as a filled circle, a pheromone 24 depicted as a crossed circle, and a clumping material 26 depicted as a plus sign; and a binder component 18 forming a matrix retaining the biochar granules 12, and the one or more of the fragrance 22, the pheromone 24, and the clumping material 26 and defines a granule surface 28 with a granule diameter, d. According to embodiments, a granule animal bedding and litter material includes biochar granules present from 5 to 85 percent by total weight of the dry weight of the material; one or more of a fragrance, a pheromone, and a clumping material; and a binder component forming a matrix retaining the biochar granules, and the one or more of the fragrance, the pheromone, and the clumping material.

According to embodiments, each of the granules of the granular animal bedding and litter material has a size guide number between 100 and 230 and a uniformity index of at least 40. The size of granules is determined by the size guide number/uniformity index system used in the fertilizer industry. The size guide number describes the relative granule size and is obtained by multiplying the average granule size, in millimeters, by 100. The uniformity index is a comparison of large granules to small granules. The index is expressed as a whole number between 1 and 100 with higher numbers indicating better uniformity and tighter size range. Additionally, the sizing is optionally determined in accordance with ASTM E 728-91 Volume 11.04 wherein the sizing is optionally 20% or more passing through a 14 mesh screen and retained on a 40 mesh screen.

According to embodiments, the granular animal bedding and litter material includes a fragrance, a pheromone, a clumping material, dyes, odor suppressants such as baking soda, or superabsorbent polymer granules.

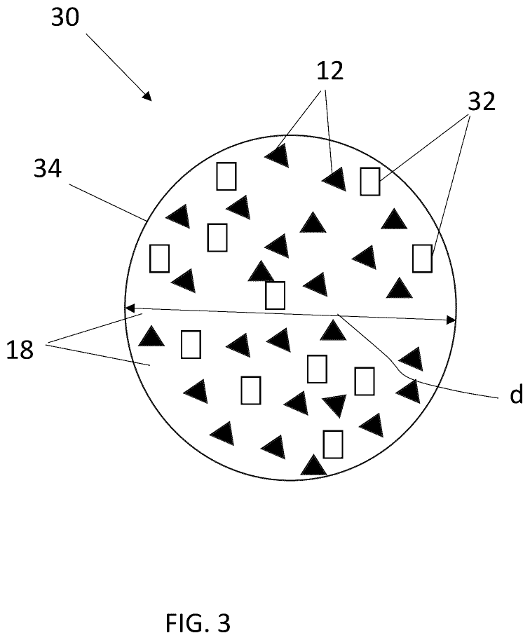

According to embodiments, the versatile biochar granule is part of a granular carrier and soil amendment material. As shown in FIG. 3, a granule 30 of the granular carrier and soil amendment material includes biochar granules 12 described above and depicted graphically as filled triangles; one or more active ingredient 32 depicted graphically as squares; and a binder 18 that forms a matrix that defines a granule surface 34 with a granule diameter, d. According to embodiments, the granular carrier and soil amendment material includes biochar granules present from 5 to 85 percent by total weight of the dry weight of the material; one or more active ingredient; and a binder component forming a matrix retaining the biochar granules, and the one or more active ingredients.

According to embodiments, each of the granules of the granular carrier and soil amendment material has a size guide number between 100 and 230 and a uniformity index of at least 40. The size of granules is determined by the size guide number/uniformity index system used in the fertilizer industry. The size guide number describes the relative granule size and is obtained by multiplying the average granule size, in millimeters, by 100. The uniformity index is a comparison of large granules to small granules. The index is expressed as a whole number between 1 and 100 with higher numbers indicating better uniformity and tighter size range. Additionally, the sizing is optionally determined in accordance with ASTM E 728-91 Volume 11.04 wherein the sizing is optionally 20% or more passing through a 14 mesh screen and retained on a 40 mesh screen.

The granules of the granular carrier and soil amendment material of the present invention in some inventive embodiments also include an active ingredient, while in other inventive embodiments no active ingredient is present. Illustrative examples of active ingredients include fertilizers, soil nutrients, amendment materials, and biostimulants. A powdered or liquid active ingredient is recognized to be operative herein. It will be recognized by those skilled in the art that more than one active ingredient may be incorporated into the granules of the granular carrier and soil amendment material and that the choice of active ingredient or combination of active ingredients will depend on the intended purpose of the granules of the granular carrier and soil amendment material and the chemical compatibility of the ingredients and other granule components. An active ingredient, if present, is included in an amount ranging from 0.05 to 10 percent by weight of the total dry weight of the particle, and the total amount of active ingredients typically are from up to 18 weight percent of the total dry weight of the granule. It is appreciated that active ingredients present in a coating on the granule are considered part of the total granule.

An active agent in powder form is optionally intermixed with mineral fragments or granules to form the inventive delivery medium combination. Without intending to be bound to a particular theory, electrostatic forces are believed to be operative to retain active agent powder in contact with the granules of an inventive medium combination.

An active agent powder adhered to an inventive granule includes any conventional active agent formulated as a powder. The active agent granules are optionally of a mean size less than 20 percent that of the mean mineral granule size. Optionally, active agent powder is sized such that the powder grain diameter has a mean particle diameter of less than 10% that of the mineral granules mean size. Optionally, the active agent powder has a mean diameter of less than 2% that of the mineral granules particle diameter. Effectively, any conventional active agent powder is operative within the present invention.

Active agents operative as part of an inventive combination illustratively include algicides, bacteriocides, defoliants, desiccants, fungicides, herbicides, insecticides, insect growth regulators, miticides, nematicides, ovicides, pesticides, pheromones, repellents, rodenticides; plant growth hormones and plant growth regulators; pest reproductive control agents; fertilizers; soil nutrients; amendment material; and a combination thereof.

Fertilizers are substances containing one of the plant nutrients nitrogen, phosphate, or potassium and illustratively include urea, sulfur-coated urea, isobutylidene diurea, ammonium nitrate, ammonium sulfate, ammonium phosphate, triple super phosphate, phosphoric acid, potassium sulphate, sodium nitrate, potassium nitrate, potassium metaphosphate, potassium chloride, dipotassium carbonate, potassium oxide, and a combination of these. These and other fertilizers as active ingredients delivered by the inventive particles are readily intermixed to achieve a variety of levels of nitrogen-phosphorus-potassium, as commonly referred to as an N—P—K rating for the fertilizer.

A fertilizer is optionally bioavailable nitrogen. Bioavailable nitrogen is nitrogen in a form that fills a nutritional requirement of a plant either directly, where the plant is capable of physiological processing of a nitrogen containing ingredient, or indirectly, where another organism such as a bacterium must first act on the nitrogen containing ingredient to produce a nitrogen form usable by the plant. Illustrative examples of a bioavailable nitrogen containing ingredient include methylene urea oligomers, oxamide, urea formaldehyde-based compounds, dicyandiamide, crotilidiene diurea, nitrocellulose, metal ammonium phosphates, ammonium nitrate, ammonium sulfate, urea, coated urea, monoammonium phosphate, diammonium phosphate, calcium nitrate, isobutylidene diurea and other fertilizers as detailed herein.

Optionally, the bioavailable nitrogen containing ingredient is a methylene urea oligomer or a mix of methylene urea oligomers as represented by the formula NH2CONH(CH2NHCONH2)nH, where n is an integer from 1-10. Illustrative examples of methylene urea oligomers include methylene diurea (NH2CONHCH2NHCONH2), dimethylene triurea (NH2CONHCH2NHCONHCH2NHCONH2), trimethylene tetraurea and tetramethylene pentaurea. Optionally a mix of methylene urea oligomers such as the material commercially sold as NUTRALENE® by Nu-Gro Technologies, Canada, the material sold commercially as Methex-40 by Homestead Corporation and the material sold commercially as NITROFORM® are used. A mix of methylene urea oligomers suitable for incorporation in the granules of the present invention are methylene urea oligomer aggregates having a mean aggregate domain size less than 420 micrometers.

Where the active ingredient is a fertilizer, soil nutrient or amendment material, the fertilizer, soil nutrient or amendment material active ingredient is optionally present in an amount ranging from 0.05% to 80% by weight of the total dry weight of the granule. Optionally, the fertilizer, soil nutrient or amendment material active ingredient is present in an amount ranging from 0.1% to 30% by weight of the total dry weight of the granule. Optionally, the fertilizer, soil nutrient or amendment material active ingredient is present in an amount ranging from 0.5% to 10% by weight of the total dry weight of the granule.

One or more lightweight additives are optionally included with the mineral and biosolid materials to obtain the desired bulk density of the finished granule. The manufactured granules optionally include about 5 wt % to about 25 wt % of the additives. The lightweight additives are optionally inert compounds having a bulk density of less than 35 pounds per cubic foot and a sizing of at least 20% passing through a 40 mesh screen. Optionally, the additives have a sizing of 100% passing through a 40 mesh screen. The lightweight material is optionally a non-fibrous material as indicated by the sizing parameters. Lightweight additives illustratively include expanded silica, fly ash, hydrated lime, wheat flour, wood flour, ground wheat straw, corn cob, corn stover, cellulose and soy flour. However, other inert compounds meeting the bulk density and sizing specifications may be suitable for use in the present inventive composition.

According to embodiments, a binder is present in an inventive pellet or granule in an amount ranging from 0.7 to 20 percent by total weight of the dry weight of the inventive pellet or granule. In a further embodiment, the binder component is present in an amount ranging from 0.9 to 10 percent by weight of the dry weight of the inventive pellet or granule. In an admixture of two constituent particles, a constituent particle designed to deliver biosolids may a have a binder component present in an inventive particle in an amount ranging from 0.1% to 70% by weight of the dry weight of the inventive pellet or granule. In a further embodiment, the binder component is present in an amount ranging from 1% to 25% by weight of the dry weight of the inventive pellet or granule. A binder component is included in a pellet or granule as necessary to produce or promote cohesion in forming a pellet or granule capable of retaining a specified form during transport and/or distribution and inhibits the dusting and attrition associated with prior art products.

A binder component operative herein includes bentonite clay, carbohydrate, protein, lipid, synthetic polymer, glycolipid, glycoprotein, lipoprotein, lignin, a lignin derivative, a carbohydrate-based composition, and a combination thereof. Carbohydrate binder components operative herein illustratively include a monosaccharide, a disaccharide, an oligosaccharide, a polysaccharide and combinations thereof. Specific carbohydrate binders illustratively include glucose, mannose, fructose, galactose, sucrose, lactose, maltose, xylose, arabinose, trehalose and mixtures thereof such as corn syrup; celluloses such as carboxymethylcellulose, ethylcellulose, hydroxyethylcellulose, hydroxy-methylethylcellulose, hydroxyethylpropylcellulose, methylhydroxyethyl-cellulose, methylcellulose; starches such as amylose, seagel, starch acetates, starch hydroxyethyl ethers, ionic starches, long-chain alkyl starches, dextrins, amine starches, phosphates starches, and dialdehyde starches; plant starches such as corn starch and potato starch; other carbohydrates such as pectin, amylopectin, xylan, glycogen, agar, alginic acid, phycocolloids, chitin, gum arabic, guar gum, gum karaya, gum tragacanth locust bean gum, and complex carbohydrate-based compositions containing organic and inorganic ingredients such as molasses. Oil binder components operative herein illustratively include vegetable oils such as corn, soybean, peanut, canola, olive and cotton seed. Lignin binder components operative herein include a lignin and nitrolignin; derivatives of lignin such as lignosulfonate salts illustratively including calcium lignosulfonate and sodium lignosulfonate and complex carbohydrate-based compositions containing organic and inorganic ingredients such as molasses. Suitable protein binders operative herein illustratively include soy extract, zein, protamine, collagen, and casein. Binders operative herein also include synthetic organic polymers capable of promoting or producing cohesion of particle components and such binders illustratively include ethylene oxide polymers, polyacrylamides, polyacrylates, polyvinyl pyrrolidone, polyethylene glycol, polyvinyl alcohol, polyvinylmethyl ether, polyvinyl acrylates, polylactic acid, and latex. In specific inventive embodiments, the binder component is a lignin derivative and in still other inventive embodiments is calcium lignosulfonate. In other inventive embodiments, the binder component is molasses, a liquid corn starch, a liquid corn syrup, or a combination thereof. It is appreciated that a water soluble or water swellable binder is particularly well suited to impart water dispersibility to an inventive particle.

The binder is generally added to the composition as a solution. The solution is typically provided as a waterbased slurry having about 40% to 50% solids by weight and weighing about 10 pounds per gallon. The binder may also be added and mixed with the other dry ingredients, subsequently mixing in an amount of water.

Formation of an inventive biochar granule and pelletized or granular products containing the biochar granule readily occurs through pan agglomeration of biochar, additional ingredients as detailed above, and a binder. It is appreciated that biochar is added as pre-sized powder or is milled together with other ingredients prior to combination with a binder.

The mixing of the biochar granules and pelletized or granular products containing the biochar granule may occur in either a batch or continuous mixing process. Conventional mixing devices are suitable for use with the present invention. The components should be thoroughly mixed at conditions which prevent degradation or compaction of the materials. During the mixing step, the binder composition is optionally added to the mixture as a solution. Optionally, at least part of the water soluble binder may be added to the pelletizing apparatus during pelletizing. Additional water, up to about 15 percent by weight, may be necessary for agglomeration of the materials in the inventive composition.

The binder is generally added to the composition as a solution. The solution is typically provided as a water-based slurry having about 40 to 50 percent solids by weight and weighing about 10 pounds per gallon. The binder may also be added and mixed with the other dry ingredients, subsequently mixing in an amount of water.

The admixture is then fed into a pelletizing apparatus to produce the manufactured granules of the present invention. Conventional pelletizing equipment is suitable for use in producing the particle. Optionally, pelletizing equipment is an agglomeration pan. Additionally, drum granulators or other types of granulation equipment may be used to produce the granules of the present invention.

In accordance with the present invention, the operation of an agglomeration pan may vary with the specific formulation or ingredients in order to produce a granule with the preferred properties. For example, feed rates and locations of the admixture or the water, the angle of the pan, the speed of rotation of the disc, or the depth of the pan may be varied to produce the desired product. One skilled in the art of pelletizing is capable of recognizing the variables and making adjustments to obtain the inventive granules in particle form.

The inventive granules are then dried to a temperature of from about 115 to about 150° C. to remove excess water utilized during the agglomeration of the components. The granule is dried to a total moisture content of 8% or less in accordance with ASTM standard D 5033 Volume 11.04. The granules optionally have total moisture content of 5 total weight percent or less. The upper temperature limitation during the drying step prevents the degradation or burning of the organic binder. The granules are optionally dried in conventional drying units such as, for example, a fluid bed dryer, or a rotary dryer.

The resulting granular material is then screened to remove oversized and undersized particles. The improperly sized material is optionally recycled to the mixing stage or milled to the appropriate size and rescreened. In some inventive embodiments, the finished product is sprayed with a lightweight mineral oil to further prevent dusting of the product in bulk form.

The strength of the granules is determined through the crush strength test, ASTM E 382 Volume 3.06, and resistance to attrition (RTA) test, ASTM E 728-91 Volume 11.04. In some inventive embodiments, manufactured granules of the present invention have a crush strength between 2 and 6 pounds on an 8 mesh (2.38 mm) particle. Additionally, the granules in some inventive embodiments have an RTA value of at least 85%.

The resulting granules of the present invention in some inventive embodiments have a smooth surface and are spherical in shape. The spherocity promotes flow characteristics of the granules in bulk form. The angle of repose is a test utilized to measure the ability of granules to flow in bulk form. The test is conducted on a 14×30 mesh sample. The granules of the present invention optionally all have an angle of repose of 35 degrees or less.

Some embodiments of the inventive granules promote the growth of targeted desirable organisms illustratively including cultivated plants such as lawn grass, crops, flowers, shrubs, trees, and bushes. Other embodiments of the inventive granules promote bedding and nesting of animals and act to absorb animal waste and reduce odor associated therewith.

The granules of the present invention have minimal dust as measured by smoke meter opacity compared to conventional forms of biochar with humics.

Any patents or publications mentioned in this specification are indicative of the level of those skilled in the art to which the invention pertains. These patents and publications are herein incorporated by reference to the same extent as if each individual publication was specifically and individually indicated to be incorporated by reference.

One skilled in the art will readily appreciate that the present invention is well adapted to carry out the objects and obtain the ends and advantages mentioned, as well as those inherent therein. The present methods, procedures, treatments, molecules, and specific compounds described herein are presently representative of preferred embodiments, are exemplary, and are not intended as limitations on the scope of the invention. Changes therein and other uses will occur to those skilled in the art which are encompassed within the spirit of the invention as defined by the scope of the claims.

1. A pellet material formed of granules, the pellet comprising:
biochar granules present from 5 to 100 percent by total weight of the dry weight of the inventive pellet; and
at least one of carrier granules or a binder component forming a matrix retaining the biochar granules.

2. The pellet of claim 1 wherein the biochar granules are sourced from cob.

3. The pellet of claim 1 wherein the biochar granules are sourced from one or more of rice hulls, wood chips, grasses, nut shells, corn stover, bagasse, peanut hull, vines, pulp, waste paper, cardboard, or grain chaff.

4. The pellet of claim 1 wherein the biochar granules are sourced from biosolids.

5. The pellet of claim 1 wherein the biochar granules are sized to have less than 5 weight percent being +40 mesh and more than 20 weight percent being −100 mesh.

6. The pellet of claim 1 wherein the biochar granules are sized greater than 40 weight percent of the biochar are −100 mesh weight percent.

7. The pellet of claim 1 wherein greater than 60 weight percent of the biochar granules are −100 mesh weight percent.

8. The pellet of claim 1 wherein greater than 5 weight percent of the biochar granules are −200 mesh weight percent.

9. The pellet of claim 1 wherein greater than 30 weight percent of the biochar granules are −200 mesh weight percent.

10. The pellet of claim 1 wherein loading of the biochar ranges from 5 to 80 by total weight of the dry weight of the inventive pellet.

11. The pellet of claim 1 wherein the pellet has a length that ranges from 5 mm to 45 mm, and a diameter that ranges from between 5 mm to 10 mm.

12. The pellet of claim 1 wherein the carrier granules are present and composed of at least one of cob, sorghum, rice hulls, wheat, grain chaff, bagasse, clay, wood dust, Granlime, pine, wheat, starch, paper, pulp, soy, nut shells, dolomite, granite, wood, sand, oat straws, cotton shields, agricultural waste, consumer waste, or a combination thereof.

13. The pellet of claim 1 wherein the binder is present.

14. The pellet of claim 13 wherein the binder is guar gum.

15. The pellet of claim 1 further comprising at least one of a pheromone, starch, a fragrance, or a dust control agent.

16. A pelletized animal bedding and litter material formed of granules, the pellets comprising:
biochar present from 5 to 85 percent by total weight of the dry weight of the material;
one or more of a fragrance, a pheromone, and a clumping material; and
a binder component forming a matrix retaining the biochar, and the one or more of the fragrance, the pheromone, and the clumping material.

17. The material of claim 16 wherein the biochar granules are sourced from one or more of cob, biosolids, rice hulls, wood chips, grasses, nut shells, corn stover, bagasse, peanut hull, vines, pulp, waste paper, cardboard, and grain chaff.

18. A pelletized carrier and soil amendment material formed of granules, the pellets comprising:
biochar present from 5 to 85 percent by total weight of the dry weight of the material;
one or more active ingredients; and
a binder component forming a matrix retaining the biochar granules, and the one or more active ingredients.

19. The material of claim 18 wherein the biochar granules are sourced from one or more of cob, biosolids, rice hulls, wood chips, grasses, nut shells, corn stover, bagasse, peanut hull, vines, pulp, waste paper, cardboard, and grain chaff.
